(19) United States
(12) Patent Application Publication
(10) Pub. No.: US 2008/0181324 A1
(43) Pub. Date: Jul. 31, 2008

(54) SYSTEMS AND METHODS FOR SCALING TO EQUALIZE NOISE VARIANCE

(75) Inventors: Deric W. WATERS, Dallas, TX (US); Anuj BATRA, Dallas, TX (US); Srinath HOSUR, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/022,927

(22) Filed: Jan. 30, 2008

Related U.S. Application Data
(60) Provisional application No. 60/887,239, filed on Jan. 30, 2007.

(51) Int. Cl. H04L 27/28

(52) U.S. Cl. 375/260

(57) ABSTRACT

In order to enable multiple input-multiple output (MIMO) equalization, including as an example minimum mean-squared error (MMSE) MIMO equalization, to be implemented using a conventional QR decomposition, it is beneficial to force the noise variance of each of the channel outputs to be equalized. Embodiments scale the channel outputs in order to create an effective channel whose outputs have approximately the same noise variance. Embodiments comprise systems and methods for a channel outputs scaler to apply at least one scaling factor to each channel output of a channel outputs vector to thereby equalize the noise variance among the channel outputs.

### CROSS-REFERENCE TO RELATED APPLICATIONS

The present application claims priority to U.S. provisional patent application Ser. No. 60/887,239, filed Jan. 30, 2007, and entitled “Scaling to Equate Noise Variance”, hereby incorporated herein by reference.

### BACKGROUND

As consumer demand for high data rate applications, such as streaming video, expands, technology providers are forced to adopt new technologies to provide the necessary data rates. Multiple Input Multiple Output (“MIMO”) is an advanced radio system that employs multiple transmit antennas and multiple receive antennas to simultaneously transmit multiple parallel data streams. Relative to previous wireless technologies, MIMO enables substantial gains in both system capacity and transmission reliability without requiring an increase in frequency spectrum resources.

MIMO systems exploit differences in the paths between transmit and receive antennas to increase data throughput and diversity. As the number of transmit and receive antennas is increased, the capacity of a MIMO channel increases linearly, and the probability of all sub-channels between the transmitter and receiver fading simultaneously decreases exponentially. As might be expected, however, there is a price associated with realization of these benefits. Recovery of transmitted information in a MIMO system becomes increasingly complex with the addition of transmit antennas.

Many multiple-input multiple-output (MIMO) detection algorithms have been proposed in the literature. The optimal algorithm is conceptually simple, but is often impractical because its complexity increases exponentially with the number of channel inputs. As a result, algorithms have been proposed to solve the problem with less complexity, with the unfortunate effect of also significantly sacrificing performance. A summary of many MIMO detectors may be found in D. W. Waters, “Signal Detection Strategies and Algorithms for multiple-Input Multiple-Output Channels”, Georgia Institute of Technology, PhD dissertation, December 2005, including many variations of the sphere detector that minimize complexity without sacrificing performance. In particular, using the minimum mean-squared error (MMSE) criterion has been a popular way to get better performance from low-complexity detectors. However, conventional MMSE equalization assumes that additive noise on each channel output has the same noise variance. In practice, this assumption is frequently not true, which makes implementing detectors overly complex.

### BRIEF DESCRIPTION OF THE DRAWINGS

For a detailed description of exemplary embodiments, reference will now be made to the accompanying drawings, which are not necessarily drawn to scale, and in which:

FIG. 1 illustrates a block diagram of an exemplary communication system in which embodiments may be used to advantage; and

FIG. 2 shows a block diagram of embodiments of a channel outputs scaler.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software. It will be appreciated that the term “equalize” (not to be confused with “equalization”) as used herein, means that the referenced function or processing makes two quantities or values equal or nearly equal.

### DETAILED DESCRIPTION

In light of the foregoing background, embodiments provide a novel algorithm and architecture for scaling to equalize the noise variance of multiple channel outputs. Embodiments enable equalization, for example, minimum mean-squared error (MMSE) equalization to be easily implemented even when the channel outputs have different noise variances.

To better understand embodiments of this disclosure, it should be appreciated that the MIMO detection problem—namely, to recover the channel inputs given the channel outputs when there are multiple inputs and outputs—can be described using a narrowband channel model written as:

r=Ha+w (1)

where H is an M×N matrix, a is a signal vector such that a=[a₁, a₂ . . . a_{N}]^{T} is an N-dimensional vector of symbols that may be drawn from different alphabets, and the noise has the autocorrelation matrix E└ww*┘=Σ², For the sake of simplicity of explanation, the present discussion focuses on two cases of Σ². First, is the case when Σ²=diag(σ₁² σ₂² . . . σ_{N}²), and second is the most-general case when the off-diagonal elements of Σ² are non-zero. It will be appreciated that equation (1) also applies to any single tone in a MIMO-OFDM (orthogonal frequency divisional multiplexing) system, at least because a single tone in a MIMO-OFDM system may also be considered a narrowband channel. An example of a MIMO-OFDM receiver that could benefit from present embodiments is described in patent application Ser. No. 11/926,996 for “Dynamic Resource Allocation to Improve MIMO Detection Performance”, hereby incorporated herein by reference.

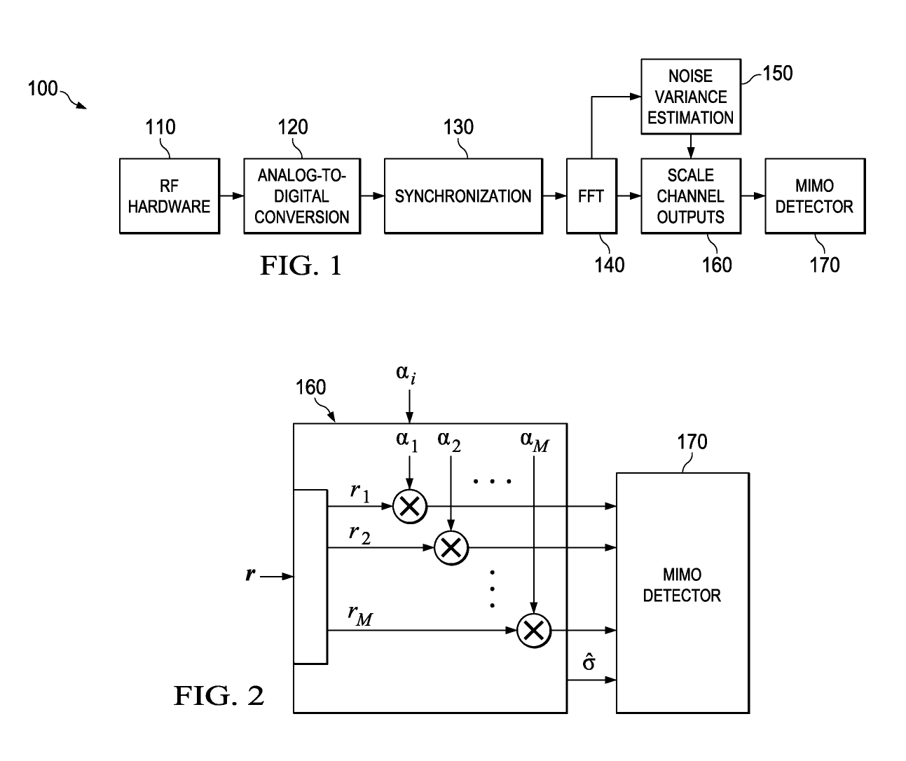

FIG. 1 is a block diagram of an exemplary communication system 100 comprising a channel outputs scaler. Specifically, a wireless (e.g., radio frequency) stream of information is received at RF receiver (often implemented in hardware) 110, converted to a digital stream at analog-to-digital converter 120, and synchronized at 130. At this point synchronizer 130 has located the start of the packet, and the digital stream is passed through a fast-Fourier transformation (FFT) at 140. It will be appreciated that analog-to-digital converter 120, synchronizer 130 and FFT 140 may be considered part of the processing system of the stream of information, and as such may comprise more or less processing functionality than set forth here in connection with the particular system of FIG. 1. The output of FFT 140 is provided to estimator 150 which estimates the noise variance, σᵢ², of each stream, and outputs such estimation(s). One example technique for estimating noise variance is described in provisional application No. 60/887,246 for “Noise Variance Estimation” hereby incorporated herein by reference. In that example technique, two identical symbols are extracted from two related symbols to obtain a set of noise samples. A variance is computed from a subset of these noise samples. The noise variance estimate may also be revised or refined as other symbols are processed and as more noise samples are generated. If the received signal, except for the additive noise, is known—exactly or approximately—via receiver processing or other knowledge, then noise samples can be generated by subtracting the known signal from the received signal. The noise variance is estimated by computing the variance of a subset of these noise samples.

Continuing with the embodiment of FIG. 1, the outputs of FFT 140 and estimator 150 are provided to channel outputs scaler 160 where the channel stream is scaled to equalize the noise variance of multiple channel outputs using the noise variance estimation(s) on the transformed stream(s). The outputs of scaler 160 are fed to MIMO detector 170. MIMO detector 170 uses the scaled channel outputs and the estimate of their variance to perform further computations, for example information regarding the transmitted signal, which are in turn output to other components, for example a decoder, for analysis and/or processing. Embodiments of scaler 160 can provide outputs to many types of MIMO detectors. As should be understood, such MIMO detectors may contain MIMO equalization, LLR computation, and/or further scaling. One example of MIMO equalization is described in provisional patent application No. 60/887,254, filed Jan. 30, 2007 for “Hybrid-MIMO Equalization”, hereby incorporated by reference herein. An example of further scaling that may be implemented as part of a MIMO detector is described in U.S. patent application Ser. No. 11/928,050, filed Oct. 30, 2007 for “Scaling to Reduce Wireless Signal Detection Complexity”. Examples of MIMO detectors that may benefit from present embodiments include but are not limited to those disclosed in U.S. patent application Ser. No. 11/930,259, filed Oct. 31, 2007 for “Candidate List Generation and Interference Cancellation Framework for MIMO Detection”, U.S. patent application Ser. No. 11/928,863, filed Oct. 31, 2007 for “Parameterized Sphere Detector and Methods of Using the Same”, U.S. patent application Ser. No. 12/016,921, filed Jan. 18, 2008 for “Systems and Methods for Low-Complexity MIMO Detection Using Leaf-Node Prediction Via Look-Up Tables”, and U.S. patent application Ser. No. 12/016,967, filed Jan. 18, 2008 for “Systems and Methods for Low-Complexity MIMO Detection with Analytical Leaf-Node Prediction”, each of which is hereby incorporated by reference herein.

MIMO detection often involves MIMO equalization. One type of MIMO equalization uses a linear minimum mean-squared error (MMSE) filter. A linear MMSE filter applies a matrix C that minimizes the expected value of the error ∥Cr−a∥. When each channel output has the same square root of its noise variance, σᵢ=σ, this linear filter can be expressed as:

C=(H^{H}H+\hat{σ}²I)⁻¹H^{H} (2)

where \hat{σ}² is an estimate of σ², and the H superscript denotes a conjugate transpose operation. One way to compute the matrix C is to use a QR decomposition (also known as a QR factorization) of the channel. The QR decomposition is defined as follows:

$$\begin{matrix}[ \begin{matrix}H \\ \hat{σ} I\end{matrix} ] Π = [ \begin{matrix}Q \\ α \hat{σ} Π {R}^{- 1}\end{matrix} ] R \\ = \tilde{Q} R\end{matrix} \qquad ( 3 )$$

where \tilde{Q}~ is an (M+N)×N matrix with orthonormal columns, R is an N×N triangular matrix with positive and real diagonals, Π is an N×N permutation matrix, and α is a chosen parameter. In terms of this example QR decomposition the linear filter C is written as:

C≅R⁻¹Q^{H}; (4)

equation 4 is written with equality when \hat{σ}=σ. One common, albeit special, case for QR decomposition is when α=0, for which the QR decomposition equation can be simplified:

HΠ=QR, (5)

where Q is an M×N matrix with orthonormal columns, and R is an N×N triangular matrix with positive and real diagonals, and Π is an N×N permutation matrix.

The linear MMSE detector is just one example of a MIMO detector that is built on the assumption that each channel output has the same noise variance. When this assumption is not true, the QR decomposition cannot be used to compute the linear filter in the same way. However, if the channel outputs are scaled such that the channel outputs have equalized noise variances, as accomplished by the present embodiments, then the QR decomposition can be used to implement MIMO equalization.

The MIMO detector problem is sometimes simplified by creating an effective channel that is triangular during MIMO equalization. One such method of triangularizing a channel uses the conjugate transpose of Q (resulting from the QR decomposition of the channel H); such MIMO equalization operation may be defined as:

y=Q^{H}r=Rs+n (6)

where s=Π⁻¹a=[s₁ s₂ . . . s_{N}]^{T} is a permutation of the channel input vector, and n is an effective noise. Note that n may be a function of a when \hat{σ}≠0. The constellation for the i-th symbol is defined as s_{k,i} εAᵢ. It should be understood that other MIMO equalizers may not use a QR decomposition at all, but instead use a Cholesky or LU decomposition. One example of an alternative MIMO equalizer is described in U.S. Provisional Patent Application No. 60/887,254, filed Jan. 30, 2007, for “Systems and Methods for Hybrid-MIMO Equalization”, hereby incorporated by reference herein.

It is often desirable to use the QR decomposition to implement the MIMO equalization as shown in equation (6). The following are scaling embodiments that enable the QR decomposition to be used for MIMO equalization, even when the noise variance on each channel output is not the same prior to employment of one of the present scaling embodiments. Two types of scaling embodiments are described by the block diagram of FIG. 2, where the scaling factors {αᵢ}, are defined as described below.

As shown in FIG. 2, FFT 140 outputs a vector r of channel outputs to one embodiment of the scaler 160. Scaler 160 then partitions r into a vector {rᵢ}, applies scaling factors {αᵢ} and forwards the scaled channel output vector to MIMO detector 170 along with the estimate of the scaled channel outputs noise variance.

Some scaling embodiments involve scaling each channel output by the square-root of its estimated noise variance. In such case, the scaling factors are {αᵢ}={1/\hat{σ}ᵢ}. After this operation the value of noise variance for each channel output, σᵢ/\hat{σ}ᵢ, is close to one. Such embodiments reduce the complexity of further processing, e.g., QR decomposition, but in turn may require higher bit precision when the noise variance estimated by estimator 150 is much less than one.

The channel model when N=2 is written as:

$$[ \begin{matrix}{r}_{1} \\ {r}_{2}\end{matrix} ] = [ \begin{matrix}{H}_{1 , 1} & {H}_{1 , 2} \\ {H}_{2 , 1} & {H}_{2 , 2}\end{matrix} ] [ \begin{matrix}{a}_{1} \\ {a}_{2}\end{matrix} ] + [ \begin{matrix}{ω}_{1} \\ {ω}_{2}\end{matrix} ] . \qquad ( 7 )$$

If the estimated noise variance of each channel output is above a certain threshold (depends on the numerical precision of the receiver) then each channel output can be scaled. After scaling, the effective channel model is written as:

$$[ \begin{matrix}{r}_{1} / {\hat{σ}}_{1} \\ {r}_{2} / {\hat{σ}}_{2}\end{matrix} ] = [ \begin{matrix}{H}_{1 , 1} / {\hat{σ}}_{1} & {H}_{1 , 2} / {\hat{σ}}_{1} \\ {H}_{2 , 1} / {\hat{σ}}_{2} & {H}_{2 , 2} / {\hat{σ}}_{2}\end{matrix} ] [ \begin{matrix}{a}_{1} \\ {a}_{2}\end{matrix} ] + [ \begin{matrix}{ω}_{1} / {\hat{σ}}_{1} \\ {ω}_{2} / {\hat{σ}}_{2}\end{matrix} ] . \qquad ( 8 )$$

As a result, the noise variance of all effective channel outputs, rᵢ/\hat{σ}ᵢ, are approximately equal to one (approximate in some embodiments because of limited numerical precision and errors in noise variance estimate), therefore the QR decomposition of equation (3) can be used to implement equalization. In general the operation of the scaler for such embodiments can be written as:

$$\tilde{r} = {\hat{Σ}}^{- 1} r , \\ where {\hat{Σ}}^{- 1} = [ \begin{matrix}\frac{1}{{\hat{σ}}_{1}} & 0 & ⋯ & 0 \\ 0 & \frac{1}{{\hat{σ}}_{2}} & 0 & ⋮ \\ ⋮ & 0 & ⋰ & 0 \\ 0 & ⋯ & 0 & \frac{1}{{\hat{σ}}_{M}}\end{matrix} ] = diag ( \frac{1}{{\hat{σ}}_{1}} \frac{1}{{\hat{σ}}_{2}} … \frac{1}{{\hat{σ}}_{M}} ) . \qquad ( 9 )$$

Other scaling embodiments partition each noise variance estimate into two factors F and Ŝᵢ, such that \hat{σ}ᵢ=F·Ŝᵢ, where the multiple F is the common factor between the noise variance estimates of all the channel outputs, and where the remaining factor Ŝᵢ may be different for each channel output. It should be understood that F is a multiple or factor of the noise variance estimates, the value of which varies depending upon choice of implementation, e.g., a multiple of the square-root of the noise variance estimate, a multiple of the reciprocal of the square-root of the noise variance estimate, etc. For example, in one embodiment the square-roots of the noise-variance estimates have a common factor F and are factored such that \hat{σ}ᵢ=F·Ŝᵢ, yielding the scaling factors αᵢ=1/Ŝᵢ. After this scaling operation—namely, applying scaling factors of {αᵢ} equal to {1/Ŝᵢ}, or in other words, dividing rᵢ by Ŝᵢ—the noise variance for the effective channel outputs are equalized,

$${( {σ}_{i} / {\hat{S}}_{i} )}^{2} = {( F \cdot \frac{{S}_{i}}{{\hat{S}}_{i}} )}^{2} ≅ {F}^{2} .$$

Since the noise variances of the effective channel outputs are approximately equal at this point, embodiments of scaler 160 can output them for further processing, e.g., QR decomposition, MIMO detection, etc. In at least some embodiments, scaler 160 also passes the noise variance (or square-root of the noise variance) of the effective channel outputs along with the channel outputs for further processing. In some embodiments, scaler 160 does not give F as an output.

For N=2, the scaling operation may be summarized as follows:

$$[ \begin{matrix}{r}_{1} / {\hat{S}}_{1} \\ {r}_{2} / {\hat{S}}_{2}\end{matrix} ] = [ \begin{matrix}{H}_{1 , 1} / {\hat{S}}_{1} & {H}_{1 , 2} / {\hat{S}}_{1} \\ {H}_{2 , 1} / {\hat{S}}_{2} & {H}_{2 , 2} / {\hat{S}}_{2}\end{matrix} ] [ \begin{matrix}{a}_{1} \\ {a}_{2}\end{matrix} ] + [ \begin{matrix}{ω}_{1} / {\hat{S}}_{1} \\ {ω}_{2} / {\hat{S}}_{2}\end{matrix} ] . \qquad ( 10 )$$

The noise variance of rᵢ/Ŝᵢ is approximately F, therefore the QR decomposition of equation (3) can be used to implement MIMO equalization by passing the square-root of the noise variance \hat{σ}=F, or the noise variance \hat{σ}² to the MIMO detector. In general the operation of the scaler for such embodiments can be written as:

$$\tilde{r} = {\hat{Σ}}^{- 1} r , \\ where {\hat{Σ}}^{- 1} = diag ( \frac{1}{{\hat{S}}_{1}} \frac{1}{{\hat{S}}_{2}} … \frac{1}{{\hat{S}}_{M}} ) . \qquad ( 11 )$$

Other scaling embodiments do not assume that the noise on each channel output is uncorrelated. In such embodiments, the operation of the scaler can be written as:

\tilde{r}=(F\hat{Σ}⁻¹)r, (12)

where \hat{Σ}² is an estimate of the noise autocorrelation matrix Σ². Another way to implement the operation of the scaler is:

\tilde{r}=(F(\hat{Σ}²)⁻¹\hat{Σ}^{H})r. (13)

In accordance with the two previous embodiments, the factor F may be set to one, or selected so that it equals a common factor of the elements of \hat{Σ}.

The above discussion is meant to be illustrative of the principles and various embodiments of the disclosure. Numerous variations and modifications will become apparent to those skilled in the art once the above disclosure is fully appreciated. It is intended that the following claims be interpreted to embrace all such variations and modifications.

What is claimed is:

1. A system for scaling noise variance, comprising:
a channel outputs scaler for receiving a vector of channel outputs and for applying at least one scaling factor to each channel output of the channel outputs vector to thereby equalize the noise variance among the channel outputs.

2. The system of claim 1, wherein the at least one scaling factor equals a reciprocal of the square-root of an estimate of the respective channel output's noise variance.

3. The system of claim 1, wherein the at least one scaling factor equals a factor of an estimate of the noise variance of the respective channel output.

4. The system of claim 1, wherein a QR decomposition is used to implement multiple input-multiple output (MIMO) equalization.

5. The system of claim 1, wherein the channel outputs scaler provides scaled channel outputs vector to a multiple input-multiple output (MIMO) detector.

6. The system of claim 5, wherein the channel outputs scaler provides an estimate of noise variance to the MIMO detector.

7. The system of claim 5, wherein the channel outputs scaler provides an estimate of a square-root of noise variance to the MIMO detector.

8. The system of claim 1, wherein the channel outputs vector corresponds to a wireless stream of information.

9. The system of claim 1, wherein after applying at least one scaling factor to each channel output of the channel outputs vector, at least some scaled outputs are summed.

10. The system of claim 1, further comprising a noise variance estimator for receiving, and computing from a channel output, at least one estimation of noise variance among the channel outputs to provide to the scaler.

11. A method for scaling noise variance, comprising:
receiving a vector corresponding to a plurality of channel outputs; and
applying at least one scaling factor to each channel output of the channel outputs vector to thereby equalize the noise variance among the channel outputs.

12. The method of claim 11, wherein the applying further comprises applying at least one scaling factor equal to a reciprocal of the square-root of an estimate of the respective channel output's noise variance.

13. The method of claim 11, wherein the applying further comprises applying at least one scaling factor equal to a factor of an estimate of the noise variance of the respective channel output.

14. The method of claim 11, further comprising using a QR decomposition to implement multiple input-multiple output (MIMO) equalization.

15. The method of claim 11, further comprising providing a scaled channel outputs vector to a multiple input-multiple output (MIMO) detector.

16. The method of claim 15, wherein the providing a scaled channel outputs vector further comprises providing an estimate of noise variance to the MIMO detector.

17. The method of claim 11, wherein the receiving further comprises receiving a signal vector corresponding to a wireless stream of information.

18. The method of claim 11, further comprising summing at least some of the scaled channel outputs.

19. A communication system, comprising:
a receiver for receiving a stream of information;
a processing system for digitizing the stream of information and identifying a channel outputs vector of the stream of information, the vector corresponding to a plurality of channel outputs;
a scaler for applying at least one scaling factor to each channel output of the channel outputs vector such the noise variance among the channel outputs is equalized; and
a multiple input-multiple output (MIMO) detector.

20. The communication system of claim 19, further comprising a noise variance estimator for receiving, and computing from a channel output, at least one estimation of noise variance among the channel outputs to provide to the scaler.

21. The communication system of claim 19, wherein the stream of information is a wireless stream of information.

22. The communication system of claim 19, wherein the at least one scaling factor equals a reciprocal of the square-root of an estimation of the respective channel output's noise variance.

23. The communication system of claim 19, wherein the at least one scaling factor equals a factor of an estimation of a noise variance of the respective channel output.

24. The communication system of claim 19, wherein a QR decomposition is used to implement multiple input-multiple output (MIMO) equalization.
